(19) United States
(12) Patent Application Publication
(10) Pub. No.: US 2018/0248398 A1
(43) Pub. Date: Aug. 30, 2018

(54) Control Circuit, Corresponding Power Supply, Apparatus and Method

(71) Applicant: STMicroelectronics S.r.l., Agrate Brianza (MB) (IT)

(72) Inventors: Alfio Pasqua, Piedimonte Etneo (CT) (IT); Michele Grande, San Giovanni La Punta (IT); Salvatore Tumminaro, Marianopoli (CL) (IT)

(21) Appl. No.: 15/726,791

(22) Filed: Oct. 6, 2017

(30) Foreign Application Priority Data
Feb. 28, 2017 (IT) 102017000022236

(51) Int. Cl. H02J 7/00; H02J 7/04

(52) U.S. Cl. CPC H02J 7/0072; H02J 7/0006; H02J 7/0057; H02J 7/04; H02J 7/0024

(57) ABSTRACT

In some embodiments, a power supply, for example, for battery chargers of mobile telephones, includes: a control circuit having a driving terminal coupled to a control terminal of a power transistor, where the power transistor drives a primary winding of a transformer of the power supply; a current sense input for detecting a first current flowing through the power transistor; and a switched signal generator coupled to the driving terminal, the switched signal having a period that is the sum of an active time, a dead time, and a demagnetization time of the transformer. The control circuit also includes a control network coupled to the current sense input and to the switched signal generator; a regulating network having a detection unit configured to detect the first current reaching a lower limit; and a variation unit configured to increment the dead time when the active time reaches the lower limit.

### CROSS-REFERENCE TO RELATED APPLICATIONS

This application claims priority to Italian Application No. 102017000022236, filed on Feb. 28, 2017, which application is hereby incorporated herein by reference.

### TECHNICAL FIELD

The description refers generally to an electronic circuit, and, in particular embodiments, to control circuits, a corresponding power supply, apparatus and method.

### BACKGROUND

Switching power supplies with galvanic isolation between output voltage and input voltage are widely used.

These may, for example, be PWM power supplies with galvanic isolation between the primary side, which can be connected directly to the domestic electricity distribution network (for example 220 V AC), and the secondary side, which can be connected to the user.

Such systems may operate with voltage control (CV—control voltage mode) or current control (CC—control current mode), for example, depending on the load applied.

When operating with a regulated output voltage (CV mode), feedback can be obtained using a network on the secondary side and a photodiode (optocoupler) to transfer the information to the primary side.

Current control (CC mode) may be achieved using a circuit that, on the primary side, is able to intercept the demagnetization time of the transformer included in the power supply and produce, following processing, a primary current peak to obtain a desired current (target current).

In the application context set out above, a class of power supplies known as quick chargers and USB power delivery, used in conjunction with USB sockets, play an important role. Both types of power supply may include a converter in which the current value in CC mode may be configured as a function of the output voltage (for example, in quick chargers) or simply modified to determine a power target to transfer to the load (for example, in USB power delivery circuits).

As mentioned previously, in the field of switching power supplies with galvanic isolation between output voltage and input voltage, the voltage control feedback may be achieved using an optocoupler that, in addition to closing the control loop, also enables galvanic isolation to be implemented. Current control may be implemented using a circuit on the primary side including a demagnetization detection unit (demag detector) able to generate a digital signal that follows the demagnetization phase of the transformer, which can be obtained, for example, by monitoring a division of the voltage on an auxiliary winding of the (secondary) of the transformer.

U.S. Pat. No. 5,729,443 A provides an example of extensive research and innovation activity undertaken in the sector.

### SUMMARY

Despite such extensive activity, there remains a need for improved solutions.

This may be the case, for example, for applications (for example quick charger—QC and/or USB Power Delivery—USB PD) in which the point set for continuous current regulation may change depending on the desired voltage, for which, as illustrated below, some parameters may vary according to the operating point (for example input voltage VIN and output voltage VOUT), situations in which the output current is greater than desired being possible.

One or more embodiments address this requirement.

One or more embodiments may be applied to the control of switching power supplies that can for example be used in battery chargers for mobile communication devices.

One or more embodiments may concern a corresponding power supply, a corresponding apparatus (for example a battery charger for mobile communication devices including such a power supply) and a corresponding method.

One or more embodiments may address different drawbacks and limitations in the known solutions, including in relation to the function, found for example in battery chargers, referred to as current foldback, i.e., a short-circuit protection that makes it possible to reduce the mean output current, for example to approximately one tenth of the maximum current, when the output voltage is below a given voltage level.

One or more embodiments may extend the functional scope of CC mode control, for example enable the achievement of a wide range of possible variations in current gain (GI).

### BRIEF DESCRIPTION OF THE DRAWINGS

One or more embodiments are described below by way of non-limiting example with reference to the attached figures, in which:

FIG. 1 is an example block diagram of one or more embodiments,

FIG. 2 shows a possible example implementation of one of the elements in FIG. 1,

FIGS. 3 and 4 are example diagrams of possible operating criteria of the embodiments,

FIG. 5 is an exemplary diagram of a state machine of the embodiments, and

FIGS. 6-9 show waveform diagrams illustrating signals of the embodiments.

### DETAILED DESCRIPTION OF ILLUSTRATIVE EMBODIMENTS

The description below illustrates the various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

The references used here are provided merely for convenience and as such do not define the scope of protection or the scope of the embodiments.

By way of introduction to the detailed description of examples of one or more embodiments, it would be useful to summarize some of the observations made in relation to prior references.

As described, for example, in U.S. Pat. No. 5,729,443 A, when a switching power supply system such as the ones discussed herein reach a steady-state condition, the mean output current is a function of the transformation ratio between the primary side and secondary side of the transformer, of various parameters inside the device and of an amperometric design parameter Rsens, which enables the output current to be set to the desired value.

As previously mentioned, the foldback function may be particularly important in certain potential applications. One method for implementing the current foldback function, or more generally a function for varying the output current as a function of the output voltage (for example in a quick charger) or simply a function for varying the output current to modify the output power (for example in USB power delivery devices—USB PD) may be a method including different values of one of the aforementioned parameters (for example the current gain parameter G_{I}) that can be set according to the desired output current Iₒᵤₜ, or defining different values G_{Ii} for the parameter, each being able to produce a corresponding desired output current value I_{OUTi}.

It has been observed that, when operating such solutions a voltage V_{IREF} may develop on a reference node IREF (identifying a desired output current value), which may be dependent on: the demagnetization time T_{DEMAG} (it is noted that the value T_{DEMAG} identifies the demagnetization time of the transformer of the power supply and is the same as the time during which current is flowing on the secondary side), and the switching frequency fₛ=1/T_{S}, where T_{S} is the switching period.

It can be seen that, in CC mode, the values of T_{DEMAG} and of T_{S} depend on the working point of the system, i.e. on the output voltage V_{OUT} and the input voltage V_{IN}, and the voltage V_{IREF} also depends on the working point. In particular, it can be seen that V_{IREF} is a function of the output current lout (settable by design) and of the ratio T_{S}/T_{DEMAG} (function of the working point).

When the system is working in CC mode, the value T_{DEMAG} is linked to the magnetisation inductance of the transformer Lₘ and to the direct voltage drop V_{f} of the recirculation diode of the winding of the transformer.

Where T_{ON} is the time during which the transformer is magnetised (for example, by a power MOS transistor made conductive for example by a gate driver drive circuit), the value T_{S} (total switching period) is given by the sum of T_{DEMAG}, T_{ON} and a dead time T_{DEAD} during which the system is neither magnetising nor demagnetising the transformer.

In zero voltage switching (ZVS) solutions, the power MOS transistor can be powered up when the drain-source voltage of same reaches a minimum value, and the time Tᵥ taken between the end of the magnetisation and power up of the power MOS transistor (which would ideally occur exactly when V_{DS} is at its lowest point) depends on Lₚ=Lₘ+Lₗₑₐₖ (where Lₗₑₐₖ is the leakage inductance of the transformer, while Lₘ is the magnetization inductance) and by the drain capacitance C_{d} of the power MOS transistor. At the moment the power transistor is powered down and current begins to flow on the secondary of the transformer, there is again a certain time T_{DEAD1} that, when added to the value Tᵥ, identifies the value T_{DEAD}.

The considerations set out above (and the ratios derived from same) ensure that for a given application and for a given output current value Iₒᵤₜ, the values of V_{IREF} and, therefore, also the time T_{ON}, are dependent on the working point (output voltage V_{OUT} and input voltage V_{IN}).

This situation may be unsatisfactory in some applications such as, for example, where there is a need to take account of possible variations in V_{IN} in a field that may range, for example, from 80 V to 380 V.

When making AC/DC converters such as those discussed, switched-mode power supply (SMPS) controllers may be used, using a mask on the reset signal of the power MOS transistor (known as leading edge blanking, or LEB).

When the power MOS transistor is powered up and for a set period of time T_{LEB}, the reset of the PWM is inhibited, such that the voltage spike that occurs on the source just after power-up of the power MOS transistor caused by the discharge current of the capacitor C_{d} is not able to generate a reset pulse for the power MOS transistor.

It is possible to define a delay-to-output value (T_{D}) when the power MOS transistor is powered down that is equal to the sum of the intrinsic delay of the comparator of the generator of the PWM signal and the power-down delay of the power MOS transistor. Both T_{LEB} and T_{D} link the power-up time (“ON time”) of the power MOS transistor to a minimum value that is equal to T_{ONMIN}=T_{LEB}+T_{D} (typically a value of around 400-500 nanoseconds). This means that the system cannot set T_{ON} below the aforementioned T_{ONMIN}, which may, in some cases, represent an intrinsic limit of the system when regulating current.

When making a system in which the current value I_{OUT} can be configured with values that can differ by a factor of 10 (in the case of implementation of the foldback function), current regulation may hit the aforementioned limit T_{ONMIN}.

With reference (by way of example) to quantitative values, assuming a desired system in which the output current I_{OUT} can be set to two values I_{OUT1}=1.48 A and I_{OUT2}=2.22 A, it can be seen that, in order to achieve such current values, the parameter G_{I} mentioned above needs to be configurable according to the values G_{I1}=0.166 and G_{I2}=0.25.

It can be seen that, where G_{I} is set to 0.25, the time T_{ON} is always higher than T_{ONMIN}, with the system able (for all values of V_{OUT}) to correctly regulate the current I_{OUT}=2.22 A set.

Where G_{I} is set to the value 0.166, conversely, the time T_{ON} is higher than T_{ONMIN} for values of V_{OUT} greater than 0.8 V, while the time T_{ON} is less than T_{ONMIN} for values of V_{OUT} below 0.8 V.

This means that for voltages of V_{OUT} greater than 0.8 V, the system can correctly regulate the set current value to 1.48 A, while for voltages of V_{OUT} lower than 0.8 V, the system is forced to work with T_{ON}=T_{ONMIN} with the output current higher than the desired target value.

For example, calculating the output current where T_{ON}=T_{ONMIN}, it can be seen that for values of V_{OUT}<0.8 V, the current I_{OUT} increases as the value of voltage V_{OUT} drops, while for V_{OUT}>0.8 V the current remains constant at the target value. Where V_{IN} is higher, for example 380 V, the voltage V_{OUT} at which the system begins working at T_{ONMIN} is close to 2 V.

Consequently, systems in which the output current is configured by setting the parameter G_{I} display working conditions in which the output current is higher than the desired current.

This constitutes a limitation for the application itself. For example, where the foldback function is to be implemented and G_{I} is set at one tenth of the nominal value, the aforementioned problem may occur for all of the application conditions V_{IN} and V_{OUT}. In this case, it can be seen that the T_{ON} required for the current IOUT to be the target current is less than 100 ns.

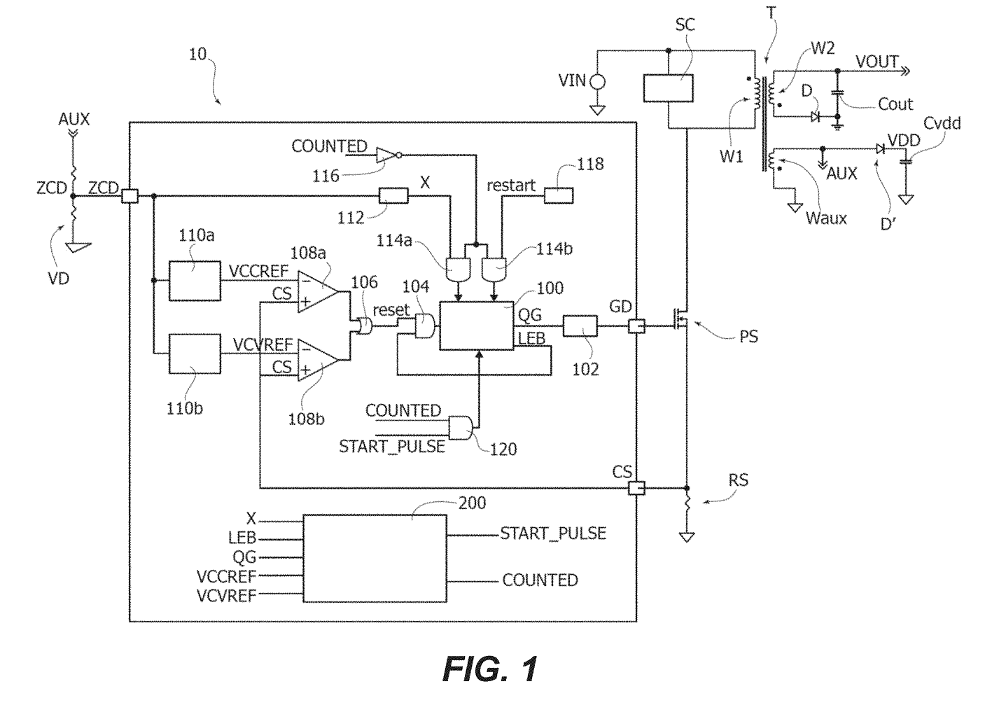

The diagram in FIG. 1 shows a possible example structure of a switching power supply.

It may, for example, be a power supply for a battery charger for mobile communication devices.

Notwithstanding the further details given below, in particular in relation to the unit indicated using reference sign 200, the structure and the operating criteria of a power supply of this type are understood to be known in the most general terms, and as such there is no need to provide a detailed description here.

For the purposes of the present document, the power supply in FIG. 1 may include a transformer T having a primary winding W1 and a secondary winding W2. An input voltage VIN can be applied to the primary winding W1, while an output voltage VOUT can be obtained from the ends of the secondary winding W2. At the ends of the secondary winding W2, where a recirculation diode D may be inserted, there is an output capacitor Cout that, like the anode of the diode D, can be referred to ground.

The transformer T can also be associated with an auxiliary winding Waux, on which a signal AUX can be detected and that can use another diode D′ to establish a voltage VDD on another capacitor Cvdd referred to ground.

The primary winding W1 of the transformer T (at the ends of which a circuit SC may be arranged to act as a “snubber”) may be acted upon by an electronic switch PS, such as a power transistor (for example a MOSFET transistor, such as a PMOS), the control terminal of which (gate, in the case of a field-effect transistor such as a MOSFET) is driven by a drive output GD of the circuit 10 discussed below.

An amperometric sensing resistor RS interposed between the transistor PS and ground is able to supply a (voltage) signal indicative of the intensity of the current flowing on the current path (source-drain in the case of a field-effect transistor such as a MOSFET) of the power transistor PS, and therefore at least approximately on the primary winding W1 of the transformer T, to a sensing input CS of the circuit 10.

The reference sign VD indicates a voltage divider (for example resistive) to which the signal AUX of the auxiliary winding Vaux can be applied, there being a signal ZCD (virtual zero-crossing) at the division point of same that can be applied to a counterpart input of the circuit 10 such as to perform (according to known criteria) a demagnetization detection function (demag detector) of the transformer T, such as to generate a digital signal X that follows the demagnetization phase of the transformer.

It can be seen that the different components discussed above and shown in FIG. 1 as being outside the circuit 10 may be different elements in different embodiments.

In one or more embodiments, the circuit 10 may include a PWM generator unit 100 (i.e. a rectangular-wave switched signal generator) that is designed to generate a signal QG (with a duty cycle that is selectively variable according to the criteria regulating generation of a PWM signal) with a period T_{S} that can be used to drive, for example via a driver 102, the output GD and, therefore, the control terminal of the power switch (power MOS) PS.

In one or more embodiments, the modulator PWM can operate as a function of different signals.

These include a first signal that can be represented by the output of a logic AND gate 104 that receives the signal LEB on one of the inputs of same (for example outputted from the PWM generator unit 100).

As discussed previously, the signal LEB can implement a mask on the reset signal of the power transistor PS, with the reset signal applied to the other input of the logic AND gate 104 from an OR gate 106 that in turn receives as input the output from a first comparator 108a and the output of a second comparator 108b, for example resetting the PWM when the reset signal is high, this reset resulting from an OR of the two output signals of the comparators 108a and 108b.

The first comparator 108a is able to compare the signal on the input CS (amperometric signal of the resistor RS) with the output VCCREF of a CC mode block 110a that “senses” the signal on the input ZCD.

The second comparator 108b is able to compare the signal on the input CS (amperometric signal of the resistor RS) with the output VCVREF of a CV mode block 110b that also “senses” the signal on the input ZCD.

The same signal ZCD is also taken to a unit 112 that transforms same into the digital signal X, i.e. the signal, discussed previously in relation to the demag detector function, that follows the demagnetization phase of the transformer T and that is powered towards two logic AND gates 114a, 114b acting on the PWM generator unit 100.

The two logic gates n₄a, 114b each receive on one input (via a logic inverter 116) a signal COUNTED discussed below, with the logic gate n₄a receiving the signal X on the other input of same from the unit 112, while the logic gate 114b receives a restart signal on the other input of same from a starter unit 118.

Reference sign 120 indicates another logic AND gate that receives the signal COUNTED on one input and a signal START_PULSE on the other input.

In one or more embodiments, the signals COUNTED and START_PULSE can be generated by a unit 200 for regulating or adjusting the switching period T_{S} in CC mode operation.

In one or more embodiments, the block 200 can receive the aforementioned signals X, LEB, QG, VCCREF, VCVREF as input.

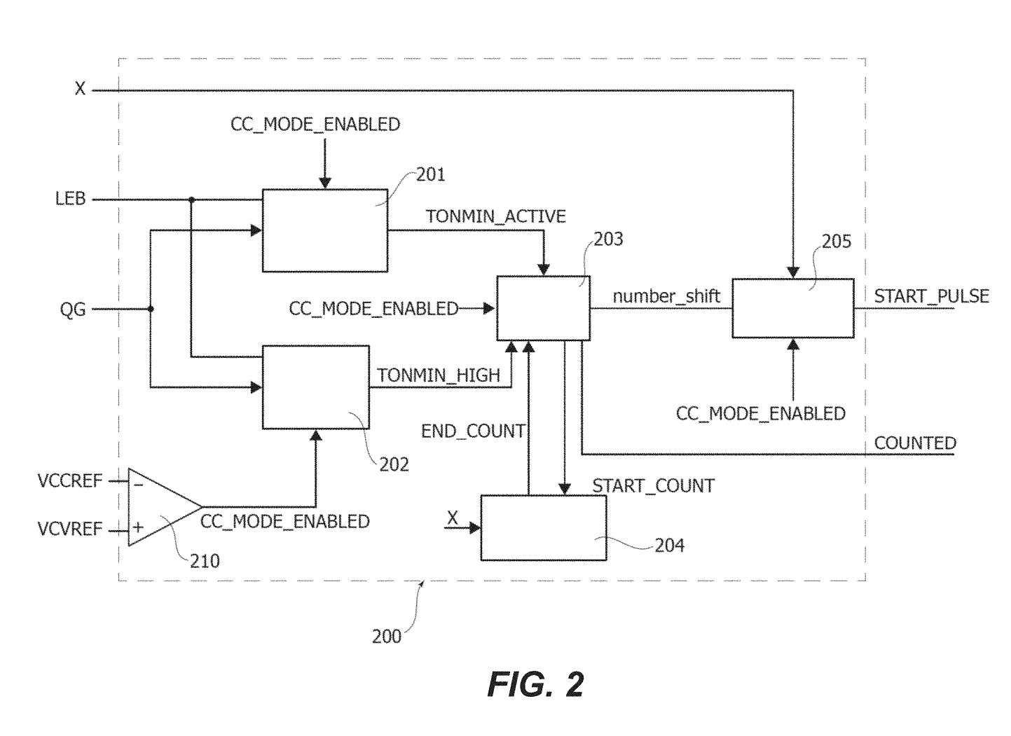

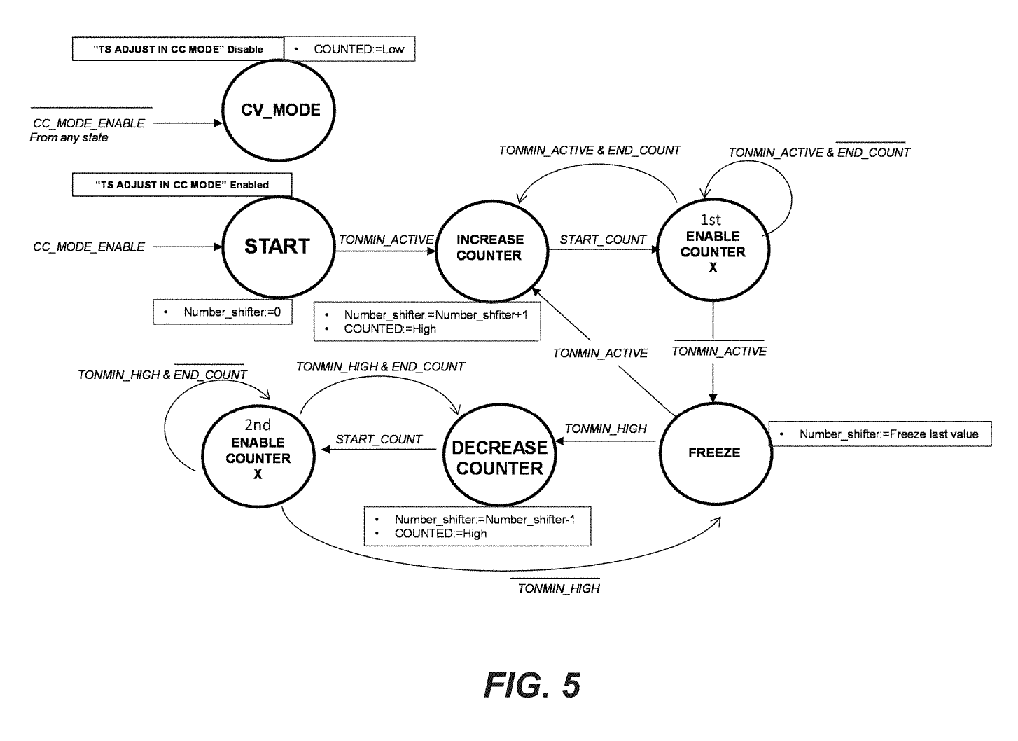

In one or more embodiments, the unit 200 can be organized as shown by way of example in FIG. 2, where the (sub) units or modules shown therein can perform the functions described below (for definitions of the elements cited, see the introduction to the present detailed description). The modules can be implemented by a processor based upon software stored in a non-transitory memory. A state machine that can be used as one implementation is shown in FIG. 5.

Unit 201: detection time T_{ONMIN} as a function of the signals LEB and QG under the control of a CC-mode enabling signal CC_MODE_ENABLED, with generation of a signal TONMIN_ACTIVE.

Unit 202: detection upper value of time T_{ONMIN} as a function of the signals LEB and QG under the control of the CC-mode enabling signal CC_MODE_ENABLED, with generation of a signal TONMIN_HIGH.

Unit 203: up/down counter also enabled by the signal CC_MODE_ENABLED, which receives the signals TONMIN_ACTIVE (unit 201) and TONMIN_HIGH (unit 202) and outputs the signal COUNTED and a signal number_shift.

Unit 204: another counter that receives the signal X as input, receiving a start-count signal START_COUNT from the counter 203 and sending an end-count signal END_COUNT to the counter 203.

Unit 205: also enabled by the signal CC_MODE_ENABLED, receives as input the signal X as well as the signal number_shift from the block 203 generating the signal START_PULSE, under the control of the signal CC_MODE_ENABLED.

In one or more embodiments, the (macro) unit 200 can perform the function of appropriately adapting the switching period T_{S} acting on the time T_{DEAD}, during operation in CC mode identified by the enabling signal CC_MODE_ENABLED that can be obtained at the output of a comparator 210 receiving the signals VCCREF and VCVREF as input.

In one or more embodiments, the comparator 210 may perform the function of identifying the current-control (CC) operating mode of the system (i.e. of the power supply).

For example, when the system is working in CC mode, the voltage level VCCREF is lower than the level VCVREF. In the opposite case, the system operates in voltage-control (CV) mode. Consequently, the signal CC_MODE_ENABLED (brought for example to a “high” logical level) can indicate CC mode operation, this signal enabling the different units described above.

In one or more embodiments, the unit 201 can perform the function of identifying the working condition in which T_{ON} of the transistor PS is precisely T_{ONMIN}. The inputs of the unit 201 are the signals QG and LEB, both coming from the PWM generator unit 100, where QG is the signal that drives the driver 102 and is therefore indicative of the on state of the transistor PS.

As seen previously, LEB is a masking time that is used to ensure masking of the reset of the transistor PS by part of the PWM generator unit 100 following the voltage spike occurring on the pin CS as a result of the discharge of C_{d} (drain capacitance) of the transistor PS occurring after power-up of the transistor PS.

In one or more embodiments, the signal TONMIN_ACTIVE (for example at a high logic level) outputted from the unit 201 can precisely indicate the condition in which the T_{ON} is precisely T_{ONMIN}.

In one or more embodiments, the unit 202 can perform the function of identifying the working condition in which T_{ON} of the transistor PS is higher than a given predetermined level T_{ON} HIGH greater than T_{ONMIN}. QG and LEB are inputs to the unit 202. The output signal TONMIN_HIGH (for example at a high logic level) can precisely indicate the condition in which the T_{ON} is higher than a predetermined value T_{ON}_{_}_{HIGH}>TO_{NMIN}.

In one or more embodiments, the unit 203 may perform the function of incrementing and decrementing a counter on the basis of the input signals TONMIN_ACTIVE, TONMIN_HIGH and END_COUNT, outputting a number signal number_shift that corresponds to a number to be processed by the unit 205.

A signal called COUNTED, which is for example at a high logic level when the signal number_shift is not zero, may also be outputted. This signal inhibits both the signal X (ZCD unit) entering the PWM generator unit 100 (which forces the transistor PS to be powered up, for example implementing the ZVS function) and the restart signal coming from the unit 118, forcing the unit 205 to power up again via the signal START_PULSE.

In one or more embodiments, the unit 205 may perform the function of generating a pulse that forces the transistor PS to power up (signal START_PULSE) after a given time (equal for example to number_shifter*Tfix) from the falling edge of the signal X, with the objective of increasing the switching period T_{S} of the system, necessarily increasing the time T_{DEAD}.

Possible operating modes of one or more embodiments are described below by way of example.

For example, when the system switches from CV mode to CC mode, the voltage level of the signal VCCREF goes lower than the voltage level of VCVREF, the comparator 210 switches and the signal CC_MODE_ENABLE goes for example to a high logic level, enabling the entire unit 200.

This makes it easier for the regulation mechanism for T_{S} to occur (only) when the system is operating in CC mode.

Assuming, in a possible example, that the working point of the system is such that T_{ON} is greater than T_{ONMIN}. Under such conditions the signal TONMIN_ACTIVE is at the low logic level and no action is carried out by the system, which can then continue to operate normally, for example with T_{S} equal to the typical value defined by the application. For example:

T_{S}=T_{ON}+T_{DEMAG}+T_{DEADmin}

where T_{DEADmin} is the minimum value of the time T_{DEAD} defined previously.

It is now assumed that the working point moves towards lower V_{OUT} values, enabling T_{ON} to reach the value T_{ONMIN} for V_{OUT}values of less than 2 V, for example.

As discussed previously, in the absence of any mechanism for adjusting the period T_{S}, the system would supply an output current that is higher than the target current.

In one or more embodiments, the condition for T_{ON} reaching T_{ONMIN} may be identified by the unit 201 that configures the signal TONMIN_ACTIVE, for example to the high logic level.

With TONMIN_ACTIVE high, the unit 203 can in turn switch the signal START_COUNT to the high logic level and, consequently, the unit 204 can start counting events for the signal X and, after a given number of events have been counted for the signal X (number indicated as “NeventX” for the sake of brevity), send a pulse to the unit 203 using the signal END_COUNT.

If, when counting the events for X, T_{ON} again becomes greater than T_{ONMIN}, the signal TONMIN_ACTIVE again returns to the low logic level and consequently the signal START_COUNT also goes to the low logic level and the unit 204 stops counting and resets the counter, the counter restarting from zero when START_COUNT returns to the high logic level.

Such a counting mechanism for the signal X before T_{S} is modified facilitates adjustment of T_{S} (only) after the transient on T_{ON} has passed. This transient can be attributed to the variation of the working point (for example variation of V_{OUT}) or to the change made to T_{DEAD} by the mechanism for adjusting T_{S}.

Assuming now that, while TONMIN_ACTIVE is for example high, the unit 204 finishes counting a number of events for X equal to “NeventX,” a pulse, via the signal END_COUNT, can be sent to the unit 203, which increments the number counter number_shift by one from 0 to 1 and, simultaneously, since number_shift is not 0, the signal COUNTED can be moved to the high logic level.

This prevents the signal X or the signal restart from powering up the transistor PS and enables the transistor PS to be powered up again (only) by the signal START_PULSE. The pulse START_PULSE is generated by the unit 205, which generates the pulse (precisely) after a time delay equal to number_shift*Tfix (where Tfix has a predetermined value for example if Tfix=1 microsecond and number_shift=1 number_shift*Tfix=1 microsecond) from the falling edge of the signal X.

Consequently, the period T_{S} is higher than the quantity number_shift*Tfix and, as a result of the variation of T_{S} caused by the lengthening of T_{DEAD}, the current I_{OUT} drops.

If the new current level is lower than the target value, the CC mode can act (in practice increasing the “virtual” reference V_{IREF} discussed in the introduction) and consequently T_{ON} will also be greater than T_{ONMIN} adjusting the current I_{OUT} to the target value.

By bringing T_{ON} to a value greater than T_{ONMIN}, the signal TONMIN_ACTIVE can go, for example, to a low level and the system can freeze that condition with T_{DEAD} at 1 microsecond. If the current I_{OUT}, after T_{S} has been increased, is still higher than the target current, T_{ON} is still equal to T_{ONMIN}, the signal TONMIN_ACTIVE remains, for example, high and the signal START_COUNT also remains high, the unit 204 begins a new count of the X events and, having counted “NeventX,” sends another END_COUNT pulse to the unit 203, which increments the number counter number_shift by one from 1 to 2.

In this case, the pulse START_PULSE generated by the unit 205 is sent after a time delay equal to 2*Tfix=2 microseconds from the falling edge of the signal X. This causes a further drop in the current level I_{OUT}. The process freezes in this state if T_{ON}, following the increase in T_{S}, becomes higher than T_{ONMIN}, and T_{DEAD} continues to increase if T_{ON} remains equal to T_{ONMIN}.

Again by way of non-limiting example, it can be assumed that the working point changes, assuming that the output voltage V_{OUT} moves from 0.15 V to 4.25 V. Assuming that from the aforementioned condition in which T_{DEAD} is reset to the value 4*nTfix, i.e. 4 microseconds.

Following the change in the working point, to facilitate achievement of the target value by the current I_{OUT} supplied, the system can increase the voltage of the reference V_{IREF} and consequently also T_{ON}. Without a reduction mechanism for T_{DEAD}, the reference V_{IREF} would quickly reach maximum value, with the current I_{OUT}supplied under such conditions being lower than the target value.

In one or more embodiments, in order to obviate this drawback, the unit 202 can identify the condition in which T_{ON} is greater than a predetermined value indicated using T_{ONHIGH} (which is set to a value greater than T_{ONMIN} and less than an upper limit T_{ON@Vlow} that is possible if V_{IREF}=Vlow, for example where T_{ONHIGH} is set to approximately 615 nanoseconds).

If T_{ON} is greater than T_{ONHIGH}, the signal TONMIN_HIGH is set, for example, to a high logic level, and the unit 204 begins a new count of X events, and once X reaches “NeventX,” sends an END_COUNT pulse to the unit 203, which in this specific case in which TONMIN_HIGH is high, decrements the number counter number_shift by one from 4 to 3.

The process can continue until T_{ON} is greater than T_{ONHIGH} stopping either when T_{ON} is less than T_{ONHIGH} or when number_shifter reaches 0.

In this latter case, T_{DEAD} is again equal to T_{DEADmin}, the signal COUNTED again returns to the low logic level and powering up of the transistor PS is again determined by the signal X (via the unit 112), without any additional delay, everything in principle occurring before the mechanism is activated by achievement of the condition T_{ON}=T_{ONMIN}.

Experiments carried out with two changes in the output voltage Vout, the first from 1.5 V to 0.15 V (with the system adapting by reducing the frequency of the system) and the second from 0.15 V to 4.2 V (with the system increasing the frequency returning to the starting condition) have confirmed the possibility of achieving entirely satisfactory results using one or more embodiments.

One or more embodiments may result in a system that, having identified the condition T_{ONMIN}, can increase the switching period T_{S} for example increasing T_{DEAD} (using a discrete quantity such as 1 microsecond, 2 microseconds, etc.) until the system finds another working point in which T_{ON} is greater than T_{ONMIN}.

When the working point changes, for example when the output voltage increases, T_{ON} increases. In one or more embodiments, if a given value is exceeded (for example T_{ONHIGH}), the system starts to reduce T_{DEAD}, this process being liable to stop either when T_{ON} is less than T_{ONHIGH} or when T_{DEAD} reaches the minimum value restoring the starting condition.

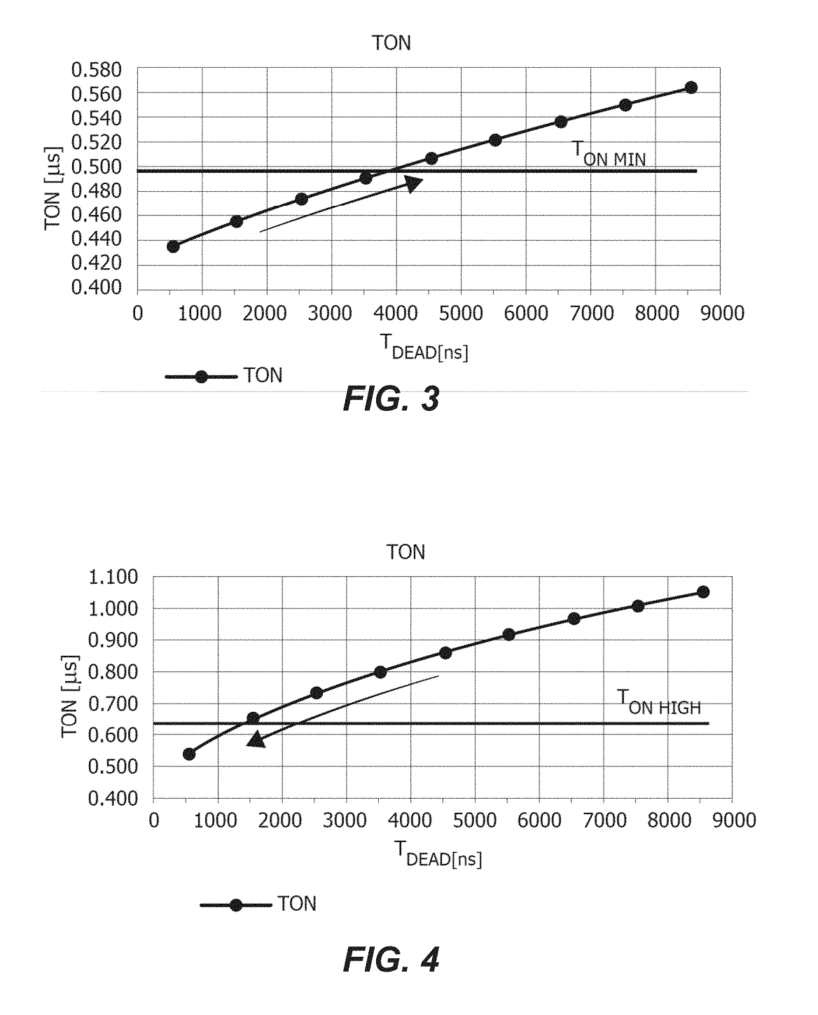

The graphs in FIGS. 3 and 4 show possible trends of T_{ON} (microseconds, y-axis) as a function of T_{DEAD} (nanoseconds, x-axis) for a given working point (for example V_{IN}=380 V, V_{OUT}=0.15 V in FIG. 3 and V_{IN}=380 V, V_{OUT}=4.15 V in FIG. 4).

The graph in FIG. 3 shows how, as T_{DEAD} increases, T_{ON} also increases, T_{DEAD} needing to be only 4 microseconds greater for T_{ON} to be greater than T_{ONMIN} (horizontal line in FIG. 3).

When working in such conditions, in one or more embodiments T_{DEAD} may be increased until T_{ON} is greater than T_{ONMIN}. Under these new conditions, the current I_{OUT} is correctly regulated.

In the example shown in FIG. 4, if the system, starting from the previous working point (V_{OUT}=0.15 V), in which the adjustment mechanism causes T_{DEAD} to move to a value of 4.5 microseconds, moves towards the new working point (V_{OUT}=4.15 V), the graph shows that T_{ON} tends to move to approximately 850 nanoseconds.

Having positioned T_{ONHIGH} (horizontal line in FIG. 4) at a value lower than 850 nanoseconds, in one or more embodiments it is possible to reduce T_{DEAD} until T_{ON} is less than T_{ONHIGH}.

One or more embodiments may work such that, within the voltage range VOUT containing the limit of T_{ONMIN}, there being no option of reducing T_{ON}, the switching frequency is reduced (increasing T_{S} by acting on T_{DEAD}) thereby forcing the system to work with T_{ONMIN}<T_{ON} <T_{ONHIGH}.

In short, one or more embodiments can detect the condition of T_{ONMIN} and correspondingly increase the switching period T_{S} by increasing T_{DEAD} appropriately (the time elapsed between the end of the demagnetization interval and actual powering up of the power switch PS), for example using discrete values of 1 microsecond, 2 microseconds and so on, until the system reaches a new working point in which T_{ON} is greater than T_{ONMIN}.

Following a change in the operating conditions, for example following an increase of the output voltage, T_{ON} also increases and, if same exceeds a predetermined value T_{ONHIGH}, the system reduces T_{DEAD}, and the process ends as a result of the fact that (i) T_{ON} is less than T_{ONHIGH} or (ii) T_{DEAD} reaches the lowest value, restoring the initial condition.

It can also be seen that the use of one or more embodiment can be compared by detecting, during operation in CC mode, quantities that can be measured from the outside, such as frequency 1/T_{S}, on time TON and dead time T_{DEAD}.

One or more embodiments may therefore concern a circuit (for example 10) including: a driving terminal (for example GD) couplable to a control terminal of a power transistor (for example PS), an amperometric input (for example CS) for detecting an amperometric signal, the amperometric signal being indicative of the intensity of the current flowing through the power transistor, a switched signal generator (for example 100) coupled (for example via the driver 102) to the driving terminal, the switched signal having a period, Tₛ, being the sum of an active time (activation of the transistor PS), T_{ON}, and a dead time, T_{DEAD}, a control network (see for example the elements 104 to 118) coupled to the amperometric input and to the switched signal generator, the control network being configured to control the active time, T_{ON}, of the switched signal as a function of the signal at the amperometric input, with the active time, T_{ON}, able to reach a lower limit, T_{ONMIN}, and a regulating network (for example 200, 120) of the switched signal generator, the regulating network comprising: a detection unit (for example 201) of the active time, T_{ON}, reaching the lower limit, T_{ONMIN}, and a variation unit (for example the counter 203) for the dead time T_{DEAD} being activatable (for example via TONMIN_ACTIVE) to increment the dead time, T_{DEAD}, as a result of the active time, T_{ON} reaching the lower limit, T_{ONMIN}.

The fact of referring to the period T_{S} as including the sum of an active time (activation of the transistor PS), T_{ON}, and a dead time, T_{DEAD}, disregarding the presence of the demagnetization time T_{DEMAG}, shows that, following detection (for example in 201) on T_{ON} (in order to check that T_{ONMIN} has been reached), and following regulation on the dead time T_{DEAD} (in order to increase the period T_{S} and reduce the frequency 1/Tₛ), one or more embodiments can be “transparent” with regard to the demagnetization time T_{DEMAG}, which in one or more embodiments may even be undetected.

One or more embodiments may include: an additional amperometric input (for example ZCD) for detecting a demagnetization signal, the demagnetization signal being indicative (for example X) of the demagnetization time, T_{DEMAG}, of a transformer (for example T) driven by the power transistor (PS), the switched signal generator coupled (for example 112, 114a) to the additional amperometric input, with the period of the switched signal, Tₛ, being the sum of the active time, T_{ON}, the demagnetization time, T_{DEMAG}, and the dead time, T_{DEAD}.

In one or more embodiments, the variation unit for the dead time, T_{DEAD}, is activatable in discrete steps (for example 1 microsecond, 2 microseconds) varying the dead time, T_{DEAD}.

In one or more embodiments, the switched signal generator may be disabled (for example LEB, 104) from resetting during a masking interval after the application of a turn-on pulse for the power transistor at the driving terminal (GD), the lower limit, T_{ONMIN}, being a function of the masking interval.

In one or more embodiments, the regulating network may include: a detection unit (for example 202) of the active time, T_{ON}, reaching an upper limit, T_{ONHIGH}, and the variation unit of the dead time, T_{DEAD}, activatable (TONMIN_HIGH) to decrement the dead time, T_{DEAD}, as a result of the active time, T_{ON} reaching the upper limit, T_{ONHIGH}.

In one or more embodiments, the regulating network may include a variation unit (for example the counter 203) of the dead time, T_{DEAD}, activatable (for example via TONMIN_ACTIVE, TONMIN_HIGH) alternatively to increment and to decrement the dead time, T_{DEAD}, as a result of the active time, T_{ON}, reaching the lower limit, T_{ONMIN}, or the upper limit, T_{ONHIGH}, respectively.

In one or more embodiments, the regulating network may be configured (for example via the signal TONMIN_ACTIVE) to maintain or change the dead time, T_{DEAD}, to a respective lower limit, T_{DEADmin}, in the presence of an active time, T_{ON}, greater than the lower limit, T_{ONMIN}.

In one or more embodiments, the regulating network may include an enabling module (210) sensitive (for example VCCREF, VCVREF) to a current control state of the power transistor, with the regulating network being enabled (only) during the current control state.

In one or more embodiments, a power supply may include: a transformer with a primary winding (for example W1) and a secondary winding (for example W2) couplable to a powered load, a power transistor (for example PS) driving the primary winding of the transformer, the power transistor (PS) having a control terminal (for example gate), an amperometric sensor (for example RS) sensitive to the current flowing in the power transistor (for example on the current path, for example source-drain in the case of a FET), and a circuit according to one or more embodiments having the driving terminal coupled to the control terminal of the power transistor, and the amperometric control input being coupled to the amperometric sensor.

In one or more embodiments: the transformer may include an auxiliary winding (for example Waux) to provide (for example via a divider VD) a demagnetization signal (ZCD) indicative of the demagnetization time, T_{DEMAG}, of the transformer driven by the power transistor, the circuit may include an additional amperometric input (ZCD) that receives the demagnetization signal, the switched signal generator may be coupled to the additional amperometric input (ZCD), with the period of the switched signal, Tₛ , being the sum of the active time, T_{ON}, the demagnetization time, T_{DEMAG}, and the dead time, T_{DEAD}.

An apparatus according to one or more embodiments, optionally a battery charger, may include a power supply according to one or more embodiments.

A method for using a circuit according to one or more embodiments may include: coupling a control terminal of a power transistor to the driving terminal, detecting an amperometric signal at the amperometric input that is indicative of the intensity of the current flowing through the power transistor, applying the switched signal (100) to the driving terminal with a period, Tₛ, that is the sum of an active time, T_{ON}, and a dead time, T_{DEAD}, controlling, via the control network, the active time, T_{ON}, of the switched signal as a function of the signal at the amperometric input, with the active time, T_{ON}, able to reach a lower limit, T_{ONMIN}, and detecting the active time, T_{ON}, reaching the lower limit, T_{ONMIN}, and incrementing the dead time, T_{DEAD}, as a result of the active time, T_{ON} reaching the lower limit, T_{ONMIN}.

As discussed above, FIG. 5 shows an exemplary diagram of a state machine of embodiments of the invention. This state machine can be implemented as known in the art. For example, the state machine can be implemented as a finite state machine using a programmable logic device, a programmable logic controller, logic gates and flip flops. In other embodiments the state machine can be implemented in software.

As shown in FIG. 5, when the CC_MODE_ENABLE signal is low, the system works in CV_MODE (Constant Voltage Mode) and no T_{S} period adjustment is performed. When CC_MODE_ENABLE goes high, the system works in CC MODE (Constant Current Mode) and, depending on the signal TONMIN_ACTIVE and TONMIN_HIGH, the system may adjust the T_{S} period.

In CC MODE, when TONMIN_ACTIVE goes high, the system goes to INCREASE COUNTER state to increment by one the number_shifter, which increases the period T_{S} of the system by an amount number_shifter*Tfix, where Tfix is a fixed time. At the same time, a counter starts to count a fixed number of T_{S} periods (1st ENABLE COUNTER X state), while a transient time due to the variation done on T_{S} is elapsed.

At the end of the count, END_COUNT signal goes high, and, if TONMIN ACTIVE is still high (TONMIN ACTIVE and END COUNT is high), the system goes again to the INCREASE COUNTER state, and the number_shifter is incremented by another unit. The system, then, goes again to the 1st ENABLE COUNTER X state, repeating the sequence.

When TONMIN_ACTIVE goes low, the system goes to the FREEZE state. In the FREEZE state, the number_shifter is held to the last one value and the T_{S} period of the system is frozen to the value (T_{S}+number_shifter*Tfix). This is maintained until the signals TONMIN_ACTIVE or TONMIN_HIGH go high. If the TONMIN_ACTIVE goes high, the system goes to the INCREASE COUNTER, repeating the sequence.

If the TONMIN_HIGH goes high, the system goes to the DECREASE COUNTER state, in which the number_shifter is decremented by one from its last value (in this way the T_{S} period is decreased by an amount of Tfix). At the same time, a counter starts to count a fixed number of T_{S} periods (2nd ENABLE COUNTER X state), while a transient time due to the variation done on T_{S} is elapsed. At the end of the count, END_COUNT signal goes high, and if TONMIN_ACTIVE is still high (TONMIN_ACTIVE and END COUNT is high) the system goes again to the DECREASE COUNTER state and the number_shifter is decremented by another unit. The system, then, goes again to the 2nd ENABLE COUNTER X state, repeating the sequence. When TONMIN_ACTIVE goes low, the system goes to the FREEZE state, repeating the sequence.

As shown in FIG. 5, the T_{ON} (on time of transistor PS) is always higher than the minimum T_{ONMIN} while also achieving a correct set-point of the IOUT.

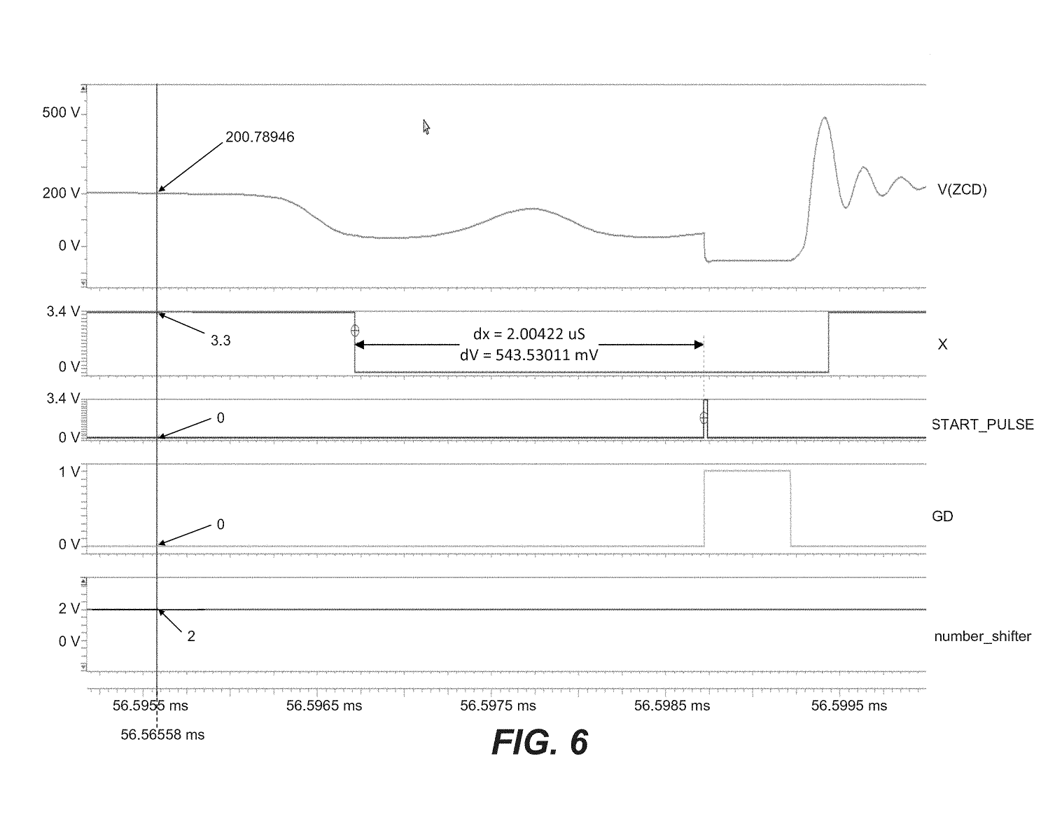

FIGS. 6-9 show waveform diagrams illustrating signals of some embodiments. FIG. 6 shows waveforms illustrating an example of how T_{S} period is increased by an amount number_shifter*Tfix. As shown in FIG. 6, in this particular example number_shifter is 2, Tfix is 1 us, so that T_{S} period is increased by 2 us. The 2 us time pulse start at the end of X signal, which is the end of the demagnetization period.

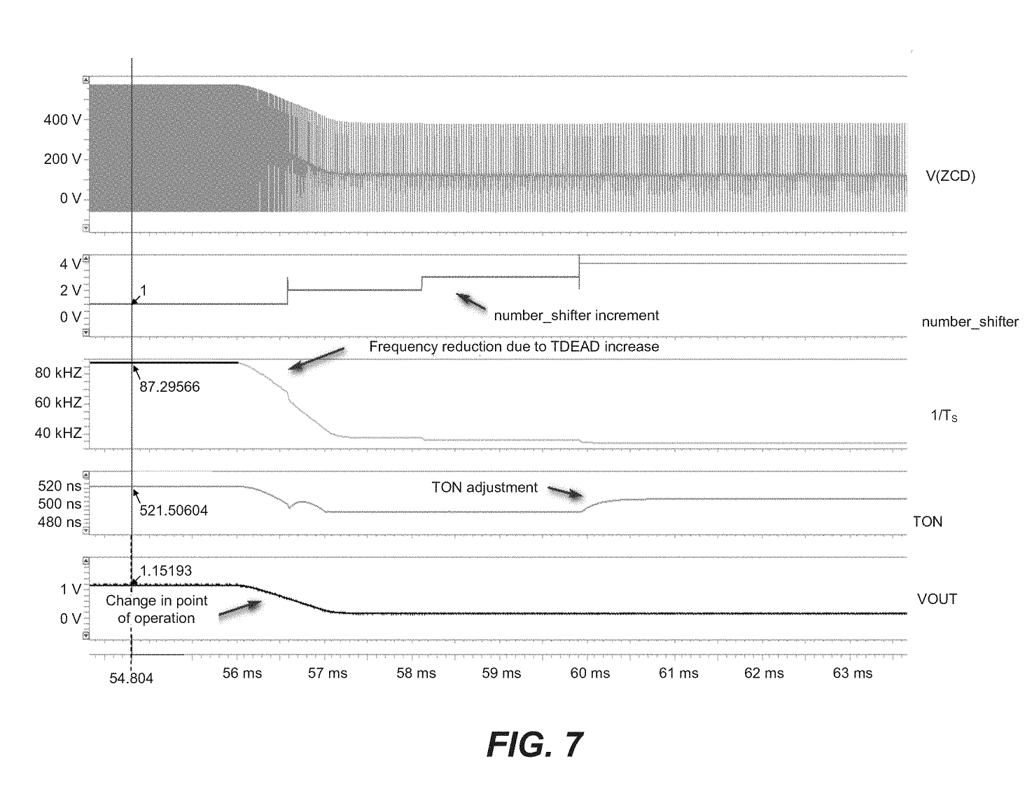

FIG. 7 shows waveforms illustrating an example of the T_{S} period is adjusted while maintaining the T_{ON} higher than the minimum T_{ONMIN}. As shown in FIG. 7, as soon as the VOUT is decreased, the T_{ON} is decreased, and when T_{ON} reaches the minimum T_{ONMIN} value, the signal TONMIN_ACTIVE goes high, starting to increase the T_{S} period by the number_shifter increment. After each increment of number_shifter, the system waits a fixed number of T_{S} before incrementing again. A soon as the T_{ON} becomes higher than the minimum T_{ONMIN}, the value of number shifters is held to the last one value.

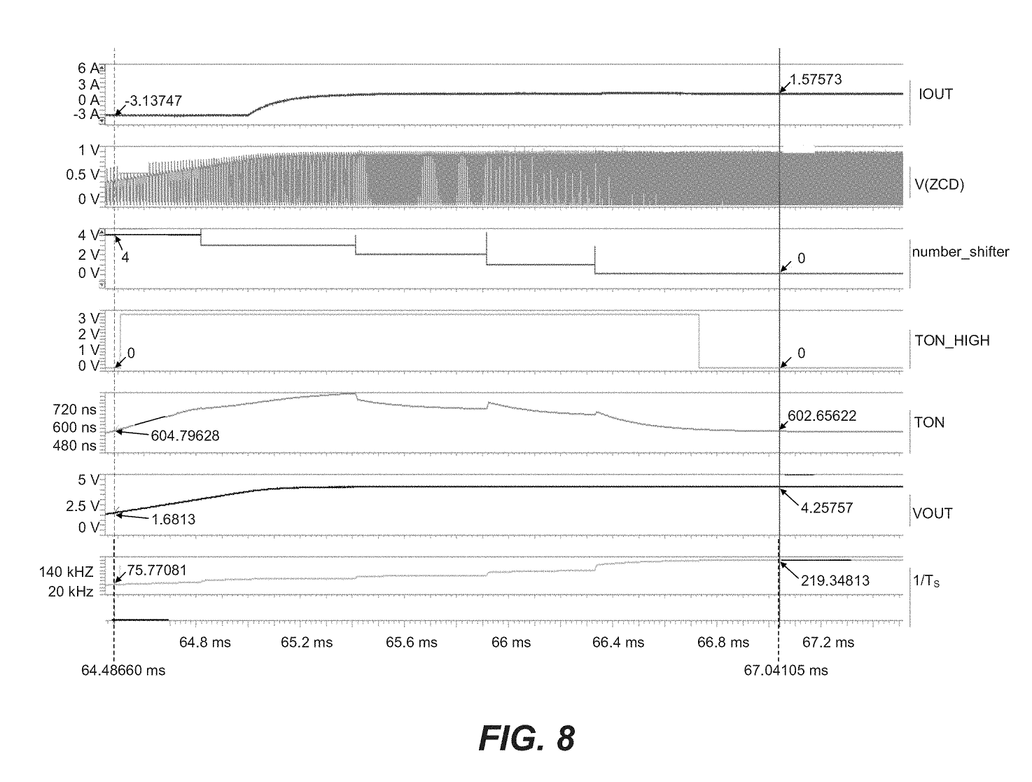

FIG. 8 shows waveforms illustrating another example. As shown in FIG. 8, when VOUT is increased, the T_{ON} increases too, and when T_{ON} reaches a value higher than a predetermined value (TONHIGH), the signal TONMIN_ACTIVE goes high. The system then decrements number_shifter, thereby decreasing T_{S} period.

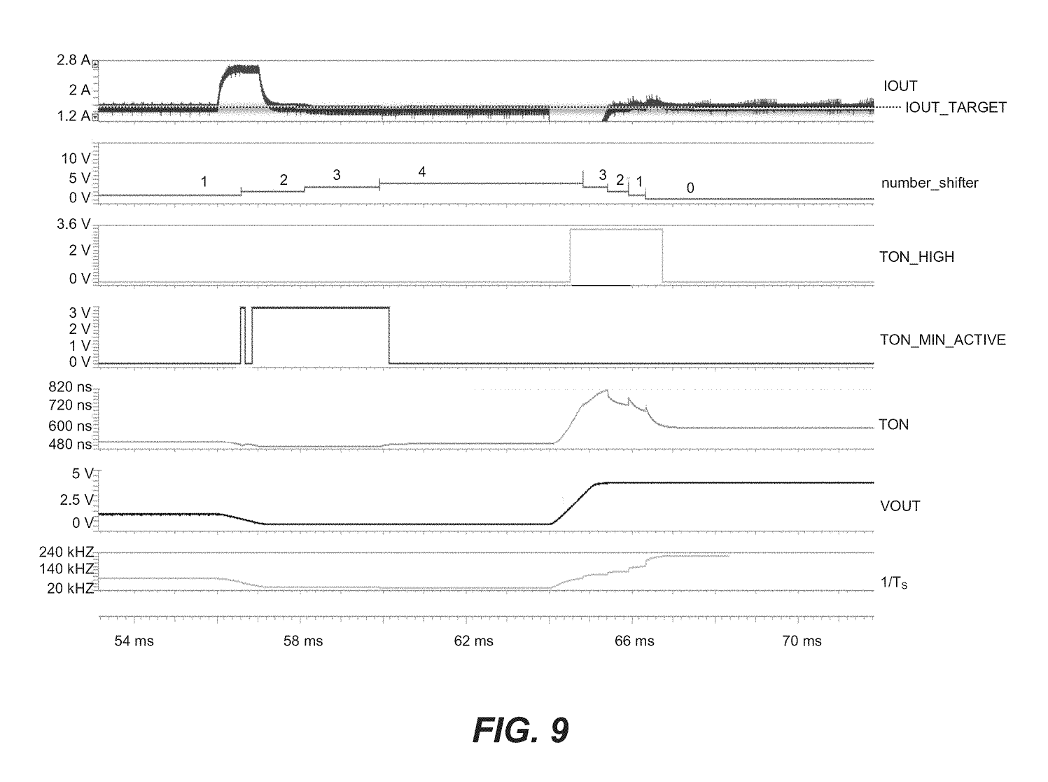

FIG. 9 shows waveforms illustrating another example. As shown in FIG. 9, after T_{S} period adjustment, the output current IOUT reaches the desired set point IOUT_TARGET.

Notwithstanding the basic principles, the implementation details and embodiments may vary, even significantly, from those given here purely by way of non-limiting example, without thereby moving outside the scope of protection.

This scope of protection is defined by the attached claims.

What is claimed is:

1. A circuit comprising:
a driving terminal configured to be coupled to a control terminal of a power transistor;
a first amperometric input configured to detect an amperometric signal, the amperometric signal indicative of an intensity of a current flowing through the power transistor;
a switched signal generator circuit coupled to the driving terminal and configured to generate a switched signal, the switched signal having a first period comprising a sum of an active time and a dead time, wherein the switched signal generator circuit comprises a regulating network, the regulating network comprising:
a lower detection unit configured to detect the active time reaching a lower limit, and
a dead time variation unit activatable to increment the dead time and increase the first period of the switched signal when the active time reaches the lower limit; and
a control network coupled to the first amperometric input and to the switched signal generator circuit, the control network configured to control the active time of the switched signal as a function of the amperometric signal.

2. The circuit of claim 1, further comprising a second amperometric input configured to receive a demagnetization signal indicative of a demagnetization time of a transformer driven by the power transistor, wherein the switched signal generator circuit is further coupled to the second amperometric input, with the first period comprising a sum of the active time, the demagnetization time, and the dead time.

3. The circuit of claim 2, wherein the second amperometric input is coupled to an auxiliary winding of the transformer.

4. The circuit of claim 3, further comprising a voltage divider coupled between the auxiliary winding and the second amperometric input.

5. The circuit of claim 1, wherein the dead time variation unit is activatable in discrete variation steps of the dead time.

6. The circuit of claim 1, wherein the switched signal generator circuit is configured to be disabled during a masking interval after application of a turn-on pulse at the driving terminal, wherein the lower limit is a function of the masking interval.

7. The circuit of claim 1, wherein the regulating network further comprises an upper detection unit configured to detect the active time reaching an upper limit, wherein the dead time variation unit is activatable to decrement the dead time, when the active time reaches the upper limit.

8. The circuit of claim 1, wherein the regulating network is configured to maintain or change the dead time to a respective lower limit when the active time is greater than the lower limit.

9. The circuit of claim 1, wherein the regulating network comprises an enabling module sensitive to a current control state of the power transistor, with the regulating network enabled during the current control state.

10. A power supply comprising:
a transformer having a primary winding and a secondary winding, the secondary winding configured to be coupled to a powered load;
a power transistor configured to drive the primary winding of the transformer, the power transistor having a control terminal;
an amperometric sensor sensitive to current flowing in the power transistor and configured to generate an amperometric signal; and
a circuit comprising:
a driving terminal coupled to the control terminal of the power transistor;
a first amperometric input coupled to the amperometric sensor, the amperometric signal indicative of an intensity of a current flowing through the power transistor,
a switched signal generator circuit coupled to the driving terminal and configured to generate a switched signal, the switched signal having a first period comprising a sum of an active time and a dead time, wherein the switched signal generator circuit comprises a regulating network, the regulating network comprising:
a lower detection unit configured to detect the active time reaching a lower limit, and
a dead time variation unit activatable to increment the dead time and increase the first period of the switched signal when the active time reaches the lower limit; and
a control network coupled to the first amperometric input and to the switched signal generator circuit, the control network configured to control the active time of the switched signal as a function of the amperometric signal.

11. The power supply of claim 10, wherein the amperometric sensor is coupled between the power transistor and ground, wherein the amperometric sensor comprises a resistor.

12. The power supply of claim ii, further comprising a snubber circuit coupled to the primary winding of the transformer.

13. The power supply of claim 10, wherein:
the transformer comprises an auxiliary winding configured to provide a demagnetization signal indicative of a demagnetization time of the transformer driven by the power transistor;
the circuit comprises a second amperometric input configured to receive the demagnetization signal; and
the switched signal generator circuit is coupled to the second amperometric input, wherein the first period comprises a sum of the active time, the demagnetization time and the dead time.

14. The power supply of claim 10, wherein the power load comprises a battery.

15. The power supply of claim 10, wherein the regulating network further comprises an upper detection unit configured to detect the active time reaching an upper limit, wherein the dead time variation unit is activatable to decrement the dead time, when the active time reaches the upper limit.

16. A method comprising:
generating with a switched signal generation circuit a switched signal at a driving terminal of a circuit, the driving terminal coupled to a control terminal of a power switch, the switched signal having a first period comprising a sum of an active time and a dead time;
detecting at a first amperometric input of the circuit a first amperometric signal indicative of an intensity of a current flowing through the power switch;
controlling, via a control network coupled to the first amperometric input, the active time as a function of the first amperometric signal;
detecting the active time reaching a lower limit; and
incrementing the dead time when the active time reaches the lower limit.

17. The method of claim 16, further comprising determining a demagnetization time based on a demagnetization signal provided by an auxiliary winding of a transformer, wherein a primary winding of the transformer is driven by the power switch.

18. The method of claim 17, wherein the dead time corresponds to a time during which the transformer is neither magnetizing nor demagnetizing.

19. The method of claim 16, further comprising disabling the switched signal generator circuit during a masking interval after application of a turn-on pulse at the driving terminal, wherein the lower limit is a function of the masking interval.

20. The method of claim 16, further comprising decrementing the dead time when the active time reaches an upper limit.
